(19) United States
(12) Patent Application Publication
(10) Pub. No.: US 2005/0119931 A1
(43) Pub. Date: Jun. 2, 2005

(54) Disparate survey score conversion and comparison method

(76) Inventor: Matthew Schall, Carrollton, TX (US)

Correspondence Address: CARSTENS YEE & CAHOON, LLP, P O BOX 802334, DALLAS, TX, 75380, US

(21) Appl. No.: 10/724,991

(22) Filed: Dec. 1, 2003

(51) Int. Cl. G06F 17/60

(52) U.S. Cl. 705/10; 705/1

(57) ABSTRACT

The invention disclosed herein generally comprises a method for converting survey scores into a single, normalized distribution which provides a mechanism by which different surveys conducted on different scales may be compared to each other on a common scale. The method consists of converting the scores of each survey to a percentage, and assigning each resultant percentage a predetermined value on the common scale, where the assignment compensates for the differences in the original disparate scale response distributions. A resampling methodology is used to create a common scale distribution, which is normal and enables the statistical comparison of scores. The results are mapped and may be transmitted to the service or product provider for assessment.

### BACKGROUND OF THE INVENTION

1. Technical Field

The present invention relates to a method for analyzing and comparing performance among and between providers in the hospitality industry, and more specifically, a method for reducing performance based survey scales and scores to a common baseline and then comparing the performance of each provider based on a common baseline score.

2. Description of Related Art

There are many providers which make up the hospitality industry in the world today. These providers include, hotels, restaurants and casinos who provide lodging, food and entertainment to both business people and recreational visitors. As one can imagine, attracting and retaining the business of patrons creates a very competitive atmosphere between hotels, restaurants, casinos and many other organizations within the hospitality industry.

In order to better service their patrons and obtain feedback from them, many hotels, restaurants and casinos distribute guest surveys to their patrons. These surveys ask the patron various questions related to the quality of the goods, services, experiences, or attitudinal reactions to what has been provided by a particular entity. For example, most hotels distribute a survey asking patrons to rate, on a certain response scale which is usually a numeric, what they thought of their room, if it was clean or dirty, if room service was prompt and courteous, and whether or not they would return for another stay at the hotel. These surveys provide the hotel with feedback which may be utilized to improve hospitality operations and provide the hotel, restaurant or casino with a competitive edge. Unfortunately, most surveys are not graded on a standardized scale, that is a multitude of different scales are in use, so the quantitative and qualitative comparison of one set of survey responses on one particular scale to the responses to similar questions answered using a different scale is not possible.

As such, the challenge faced by the hospitality industry is the accurate comparison of patron views which are rated on the various response scales used throughout the industry.

Most hotels use a seven or ten point guest survey scale to rate hotel performance and guest attitudes and experiences. The information gathered from these surveys is critical to the continued economic success of the hotel and insures guest loyalty to the property and or the brand. As such, the following background on upcoming concerns in the hospitality industry will be useful in understanding why comparing guest perceptions of hotel performance is critical to the hospitality industry.

Currently Smith Travel Research publishes results from the STAR Program, providing competitive financial and occupancy rates on over 20,000 hotels in the United States (http://www.str-online.com/products/STAR%20Program/star.html: August, 2003). A base of over 20,000 hotels represents about half of the roughly 43,000 hotels (including bed and breakfasts) in the U.S. Market. The STAR room occupancy and revenue per available room (RevPAR) data is used by hotels at the local market level to better understand their competitive environment and the forces that-drive an efficient frontier between rates and occupancy. However, there is more to setting an optimal room rate than just understanding competing hotel service provider's occupancy and RevPAR. The room rate may influence a consumer's stay decision at the moment of booking, but it does not guarantee that the consumer will be loyal to the hotel. The highest value customers are those who travel quite frequently and who are loyal to a brand, often having favorite specific hotels in each individual market. Setting room rate is a tactical decision that may or may not influence any single stay decision by these high lifetime value guests.

The goal is to stop price erosion by matching guest perceptions of the hotel experience with their expectations and the corresponding rate. Strategically, to keep rooms occupied far into the future, a property must focus on convincing guests to return and recommend its hotel. Further, hotels that fail to instill customer loyalty will continually bear the expense of having to attract new customers with discount rates, advertising, or special packages.

The behavioral measures of loyalty used in the hospitality industry may be broken down into the categories of “intent to return” and “recommend”. A recent internal research study, with data collected from over 1,000 hotels in the United States, demonstrated that guest intent to return and recommend depends on multiple factors, including staff attitudes, service quality, room characteristics, food quality, location, loyalty program, and room rate. Hotel management always reviews the room rates and occupancy of their competitors to set their own room rates, but these indicators yield little information or control over Guest Loyalty or Guest Lifetime Value (GLV). To gain control over Guest Loyalty and GLV, it is essential to take attitudes and perceptions into account. People will not return to a hotel they perceive as filthy, no matter the rate. People will always want to return to an immaculate hotel with excellent service and inexpensive food provided at the same rate as the other hotels in the area. Therefore, hotel management must consider guest stay perceptions when setting room rates to maximize GLV. Better perceptions may indicate an ability to charge a higher rate, yielding both more revenue and profit for the hotel. Facilitating the comparison of guest perceptions between competitive hotels in a local market enables each hotel to set a rate that maximizes GLV based on how guests evaluate the hotel's performance on staff, rooms, food, facilities, and location. Hence, being able to compare performance across hotels that use different scales is an essential need in the hospitality industry.

Moreover, the differences in the shape of seven point and ten point response distributions make comparison between hotels difficult for two reasons. First, in order to compare hotels, some measure needs to be found that is representative of that hotels performance, and that measure must be consistent for scores collected on both seven and ten point scales. Second, some mechanism must be developed to enable comparison of scores. That is, local market comparison scores between hotels are most useful when it is possible to tell the hotels if their scores are meaningfully different, or if the differences are just sampling error and not actionable. As such, a need exists in the art for a scoring mechanism that is consistent for different scoring scales, and a mechanism to quantify the differences between scores in a local market.

### SUMMARY OF THE INVENTION

The present invention discloses a method for converting two different score distributions into a single, normalized distribution which provides a mechanism by which different surveys conducted on different scales may be compared to each other on a common scale. The method consists of converting the scores of each survey to a percentage, and assigning each resultant percentage a predetermined value on the common scale, where the assignment compensates for the differences in the original disparate scale response distributions. Next, a resampling methodology is used to create a common scale distribution, which is normal and enables the statistical comparison of scores. Each individual hospitality entity's survey score(s) from the relevant market is combined into a single, pooled data set, and the data set is standardized so that each hospitality entities' scores have the weight. From this data set, multiple sample means are calculated using a resampling methodology and a distribution of the means is formed. Under normal distribution theory, the resulting sampling distribution of the mean will be normally distributed. The standard error of the mean, which is the standard deviation of the sampling distribution of the means, is then used to evaluate the degree of difference between scores to provide an accurate test that enables statistical performance comparison among different hospitality providers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a network in which the present invention maybe implemented; and,

FIG. 2 is a detailed block diagram illustrating the score conversion and comparison method disclosed herein.

### DETAILED DESCRIPTION OF THE PREFERRED EMBODIMENT

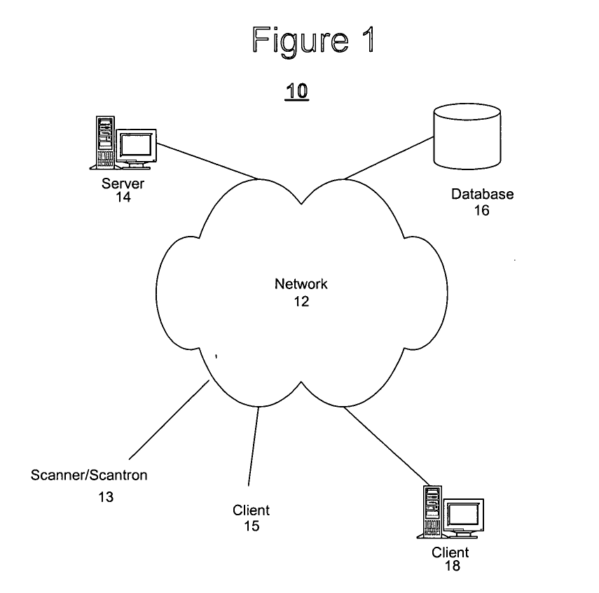

Turning to FIG. 1, a network diagram in which the present invention may be implemented is shown. FIG. 1 is a pictorial representation of a distributed data processing system 10. Distributed data processing system 10 contains a network 12 which is the medium used to provide communication links between various devices and computers connected together within distributed data processing system 10. Network 12 may include permanent connections, such as wire or fiber optic cables, or temporary connections made through telephone connections.

In the depicted example, an electronic scanner or scantron or data receiver for electronic data 13 and database 16 are connected to network 12. The scanner 13 is a hardware device with embedded software applications which provide electronic interpretation and recordation of information from various paper sources such as survey cards or “bubble” sheets as commonly known in the art or is a program that receives, parses and interprets electronically distributed data. Scanner 13 may be located on a corporate server, personal computer or be a third party service providing data interpretation and recordation services to clients 14, 15, 18. Clients 14, 15, 18 may be, for example, personal computers, network computers, servers, wireless phones or personal digital assistant devices with access to public and private networks with one or more than one individual client. For purposes of this application, a network computer is any computer coupled to the network 12. Distributed data processing system 10 may also include additional servers, clients, and other devices not shown. The invention may be easily implemented by one of ordinary skill in the art using known programming techniques and equipment.

As depicted in FIG. 1, distributed data processing system 10 is the Internet, with network 12 representing a worldwide collection of networks and gateways that use the TCP/IP suite of protocols to communicate with one another. At the heart of the Internet is a backbone of data communication lines between major nodes or host computers, consisting of thousands of commercial, government, education, and other computer systems that route data and messages. Of course, distributed data processing system 10 may also be implemented as a number of different types of networks, such as, an intranet, a local area network (LAN), or a wide area network (WAN). FIG. 1 is intended as an example and not as an architectural limitation for the present invention. For example, the basis for implementation might be as a private network within a company, at one location or several, which may or may not be connected to the public. Furthermore, the basis may be a shared computing system, which interacts with individual users through the use of terminals or computers.

Score Conversion

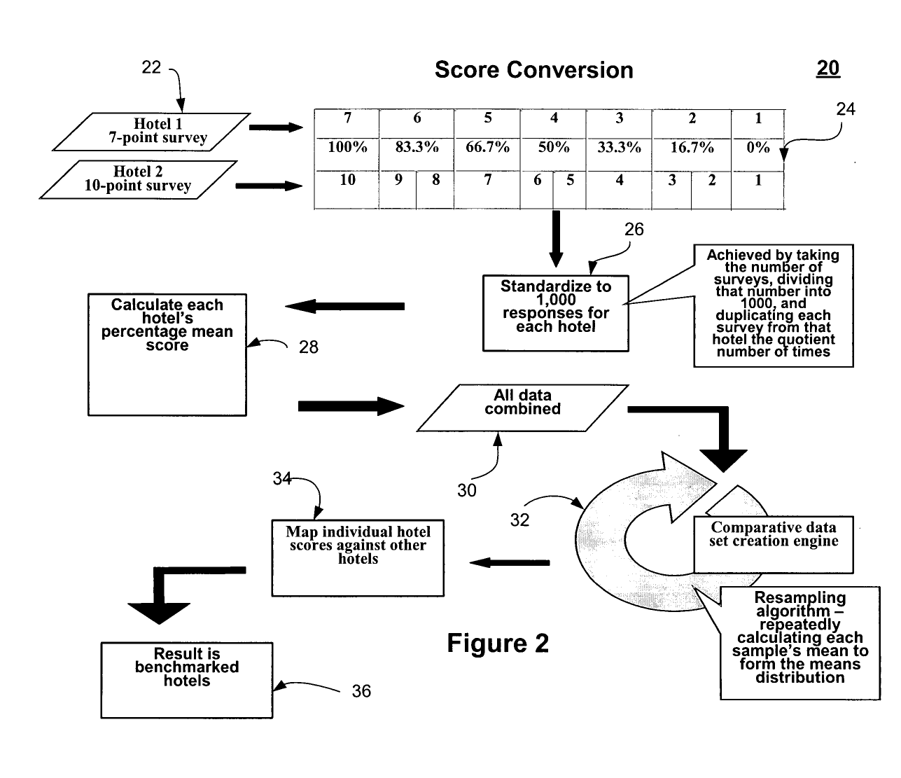

FIG. 2 shows a block diagram of the inventive method disclosed herein 20. For the purposes of illustration, the following discussion discusses the inventive methodology in the context of the hotel industry wherein patrons have responded to hotel surveys based on different scales that request information concerning the guest's opinions and attitudes or feelings regarding the hotel and hotel services. This example for illustrative purposes only, and it is recognized that the inventive method disclosed herein may be incorporated into various alternative industries and applications.

Initially, survey data or “scores” are collected and matriculated into an electronic database utilizing, in this embodiment, the distributed data processing system 10 as shown in FIG. 1. In this example, the survey scores are collected from different hotels, Hotel 1 and Hotel 2, using different survey scales (Step 22). In common practice and for the purposes of illustration herein, Hotel 1 uses a seven-point response scale and Hotel 2 uses a ten-point response scale. The collected survey scores are then converted to score percentages, with the lowest survey scores (the “1s”) receiving a value of zero percent, and the highest survey scores, seven out of seven or ten out of ten, receiving a value of 100% (Step 24). The score percentages that are in between these values on the converted scale are assigned to the preselected values as set forth in Table 1 and 2 discussed below and shown in FIG. 2.

To explain the score conversion process more clearly, consider the percentages that correspond to the scale values for a seven- and a ten-point scale. In Table 1, the bolded columns show where the score percentages match on both the primary and secondary (seven- and ten-point) scales, and the triangles show where points on the seven-point scale that are exactly midway between points on the ten-point scale.

TABLE 1
Seven Point Scale

| 7 Point | 7 | 6 | | 5 | 4 | | 3 | 2 | | 1 |
|---|---|---|---|---|---|---|---|---|---|---|
| Score | | | | | | | | | | |
| 7 Point | 100% | 83.3% | | 66.7% | 50% | | 33.3% | 16.7% | | 0% |
| Percent | | Δ | | | Δ | | | Δ | | |
| 10 Point | 100% | 88.9% | 77.8% | 66.7% | 55.6% | 44.4% | 33.3% | 22.2% | 11.1% | 0% |
| Percent | | | | | | | | | | |
| 10 Point | 10 | 9 | 8 | 7 | 6 | 5 | 4 | 3 | 2 | 1 |
| Score | | | | | | | | | | |

Ten Point Scale

The four underlined score percentages on the seven and ten point scales match in value. The average of each pair of the underlined ten-point scale score values equals the corresponding underlined seven-point scale score percentage values. If the average of the score percentage values for the responses of 2-3, 5-6, and 8-9 on the 10-point scale is taken, the resulting quotient results in the production of a set of scores that exactly match the score percentages for the seven point scale. This averaged value is assigned to both the numbers on the seven- and ten-point scales. This conversion results in the translation of one set of scores into the other, and the conversion of adjoining score pairs of values on the 10-point scale into one value on the seven-point scale increases the correspondence in the variability of the resulting scores. That is, the process makes the resulting shapes of the 7- and 10-point response distributions match each other better. The only bias introduced by this conversion is that the more unequal the numbers of twos and threes, or fives and sixes, or eights and nines, the greater the difference between the assigned mean value and the actual mean value of the scores. However, this bias has an advantage, as seen in Table 1. Most of the zero frequencies occur at 2 or 3, and by adding these cells together on the 10-point scale, the analysis proceeds to a very standard “collapsing across empty cells” approach to extrapolating missing data. Table 2 provides a listing of the preselected conversion values resulting from the score conversion process for the exemplary embodiment.

At this point, converted scores are pooled into a single data set, data table or database for subsequent resampling to build a scoring distribution. One modification to the standard resampling approach is required at this point. As some hotels may survey more guests than other hotels, they will contribute more scores to be resampled, which may unduly influence the sampling distribution of the mean, thereby potentially penalizing those hotels who contribute fewer scores. To mitigate this influence, the resampling methodology disclosed herein standardizes the number of scores each hotel contributes to approximately 1,000, by dividing the number of surveys provided by each hotel into 1000, and then duplicating each survey from that hotel by the resulting quotient number of times (Step 26).

TABLE 2

| | |
|---|---|
| Original | Converted |
| Value | Value |

7-Point Scale

| | |
|---|---|
| 7 | 100 |
| 6 | 83.3 |
| 5 | 66.7 |
| 4 | 50 |
| 3 | 33.3 |
| 2 | 16.7 |
| 1 | 0 |

10-Point Scale

| | |
|---|---|
| 10 | 100 |
| 9 | 83.3 |
| 8 | 83.3 |
| 7 | 66.7 |
| 6 | 50 |
| 5 | 50 |
| 4 | 33.3 |
| 3 | 16.7 |
| 2 | 16.7 |
| 1 | 0 |

Converted Scores Comparison

The second part of the analysis requires each service provider, or in this example each hotel's converted score, to be calculated. This process begins with taking the mean of all the transformed scores for each hotel in the comparison after the number of scores each hotel contributes has been standardized (Step 28).

To compare converted scores from different hotels requires a common distribution. For example, consider the two smoothed frequency distributions of two different hotel scores in Table 3. One distribution is of percentage scores from a hotel using a seven-point scale and the other is the percentage scores collected from a hotel using a ten-point scale. In both cases, the survey questions were identical (e.g. friendly staff, clean room, room service, hotel amenities), with the only difference being the scale size.

[image]

The initial scores tallied from each different survey response scale resulted in two distinct distribution shapes as shown in Table 3. The seven-point scale distribution rises to a peak at the high-end of the scale and has scores along its entire range. The ten-point scale distribution has zero frequencies at scores 1 and 2, and has a second inflection point at scores 6, 7, 8 that does not occur on the seven-point response scale. While the mean scores for the two distributions are essentially identical except for random fluctuation, the percentile ranks of the scores may be very different because of the differences in the shapes of their respective distributions. Further, the seven- and ten-point distributions do not correspond to any known statistical parameterization. The only statistically valid way to compare scores on the two distributions is to form a common distribution with known characteristics and usable statistical parameterization.

The present invention utilizes a resampling methodology to form the common distribution. Each of the individual scores from the hotels is combined into one pooled data set (Step 30). From this data set, the methodology takes repeated samples with replacement, the mean of each sampled score is calculated, and a distribution of the means is created using the mean scores (Step 32). Under normal distribution theory, as long as the samples are of size 30 or greater, the resulting sampling distribution of the mean will be normally distributed. The standard error of the mean, which is the standard deviation of the sampling distribution of the means, can then be utilized to evaluate the degree of difference between different hotel scores using any of a variety of conventional statistical, Bayesian or resampling tests. Next, the individual hotel scores are compared against each other or mapped (Step 34), and then provided to the hotel service provider(s) as a benchmark for purposes of improving hotel management and related services (Step 36).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of converting and comparing disparate numerical survey scores comprising:
receiving at least one survey score on a first response scale;
receiving at least one survey score on a second response scale; and,
converting each received survey score to a common response scale.

2. The method of claim 1 further comprising standardizing the number of responses.

3. The method of claim 1 further comprising converting each received survey score to a primary mean score.

4. The method of claim 3 further comprising resampling each primary mean score to form a mean score distribution.

5. The method of claim 4 further comprising providing statistical tests of differences between primary scores.

6. The method of claim 4 further comprising mapping individual scores from the mean score distribution.

7. The method of claim 6 wherein the mapped scores are transmitted to at least one service provider.

8. The method of claim 6 wherein the mapped scores are utilized for assessing at least one service or product provider's performance.

9. A computer program product on a computer useable medium, for use in a data processing system for converting and comparing disparate numerical survey scores, the computer program product comprising:
first instructions for receiving at least one survey score on a first response scale;
second instructions for receiving at least one survey score on a second response scale; and,
third instructions for converting each received survey score to a common response scale.

10. The computer program product of claim 9 further comprises instructions for standardizing the number of responses.

11. The computer program product of claim 9 further comprises instructions for converting each received survey score to a primary mean score.

12. The computer program product of claim 11 further comprises instructions for resampling each primary mean score to form a mean score distribution.

13. The computer program product of claim 11 further comprises instructions for providing statistical tests of differences between primary scores.

14. The computer program product of claim 12 further comprises instructions for mapping individual scores from the mean score distribution.

15. The computer program product of claim 14 further comprises instructions for transmitting the at least one mapped score to at least one service provider.

16. The computer program of claim 14 further comprises instructions for assessing at least one service or product provider's performance.
